(19) United States
(12) Patent Application Publication
(10) Pub. No.: US 2025/0189401 A1
(43) Pub. Date: Jun. 12, 2025

(54) METHOD AND SYSTEM FOR LEAKAGE DETECTION IN A FLUID SYSTEM

(71) Applicant: GRUNDFOS HOLDING A/S, Bjerringbro (DK)

(72) Inventor: Daniel ROSENRING, Bjerringbro (DK)

(21) Appl. No.: 18/844,879

(22) PCT Filed: Mar. 6, 2023
(86) PCT No.: PCT/EP2023/055580

§ 371 Date: Sep. 6, 2024

(30) Foreign Application Priority Data
Mar. 8, 2022 (DK) PA202270091

(51) Int. Cl. G01M 3/28

(52) U.S. Cl. CPC G01M 3/2815

(57) ABSTRACT

A method for detecting leakage in a fluid system. Some embodiments of the method comprise: receiving a plurality of measured pressure values of a fluid pressure in the fluid system measured at different points in time; computing, from the received pressure values, a first pressure gradient at a first point in time; computing, from the received pressure values, a second pressure gradient at a second point in time, later than the first point in time, wherein the fluid pressure in the fluid system at the first point in time is higher than the fluid pressure in the fluid system at the second point in time; detecting presence of a leakage responsive to the magnitude of the second pressure gradient being smaller than the magnitude of the first pressure gradient.

### TECHNICAL FIELD

The present invention relates to leakage detection in a fluid system, in particular in a water-supply system.

### BACKGROUND

Many fluid systems distribute a fluid via conduits to a plurality of fluid outlets. For example, water supply systems distribute water via pipes throughout a target structure, such as a home or a commercial building. The water supply system typically comprises a variety of outlet points at which water can be drawn from the water supply system. The outlet points are typically provided with a suitable fixture for controlling the flow of water at the outlet point, such as a valve, a faucet or the like.

Fluid systems such as water supply systems may have leaks, e.g. caused by wear and tear, by exposure to freezing temperatures, or for a variety of other reasons.

Leaks in fluid systems are generally undesirable. Apart from the loss of fluid as such, the leaked fluid may also cause considerable damage to the structure in which the fluid system is installed. Yet further, in systems that include a pump for supplying fluid to the system, e.g. so as to maintain a desired pressure in the system, a leakage results in undesired reduction of pressure. This in turn may result in unnecessarily frequent operation of the pump, thus resulting in unnecessary energy consumption and wear of the pump. Accordingly, it is generally desirable to provide a method for detecting leaks, in particular small leaks. In particular, it is desirable to provide reliable leak detection, i.e. leak detection having a low risk of failing to detect the presence of a leak and/or leak detection having a low risk of false positive detections occurring.

However, leak detection is a notoriously difficult task, in particular when the leak detection is to distinguish between undesired leakage and intentional tapping of fluid via one or more outlet points of the fluid system. In particular, small leaks may be difficult to detect, as typical signs of leakage, such as flooding or damages to structures surrounding the leak may remain undetected for long periods of time.

U.S. Pat. No. 10,935,455 discloses a method for detecting small leaks in a plumbing system. This prior art method uses a temperature sensor coupled to the water in the plumbing system if there is a leak. Additionally, during times of inactivity for fixtures in the plumbing systems, a flow sensor might measure usage of water that would indicate a leak. This prior art document further describes signal processing of pressure signals over time that can be used to detect a leak during times of inactivity. To this end, the number of time intervals where a pressure gradient is larger than a certain threshold is used as an indicator of the presence of a leak.

However, it remains desirable to provide a leak detection process that can more reliably distinguish between a leak and intended water usage.

It is further desirable to provide a leak detection process that is computationally efficient.

Moreover, it is desirable to provide a leakage detection that is flexible and works under different conditions and/or under varying conditions. In particular, it is desirable to provide a leakage detection that does not require preventing normal use of the system during leakage detection. It is further desirable to provide a leakage detection that can detect leaks, which vary in size over time.

Yet further, it is desirable to provide leakage detection that relies on only few sensors and/or that otherwise can be implemented in a cost-efficient manner. For example, it is desirable to provide a leak detection process that does not require measurement of multiple different quantities, such as temperature measurements in addition to pressure measurements.

### SUMMARY

Thus, it remains desirable to provide a leakage detection method and system that solve one or more of the above problems and/or that have other benefits, or that at least provide an alternative to existing solutions.

According to one aspect, disclosed herein are embodiments of a method for detecting leakage in a fluid system, in particular in a water-supply system.

Some embodiments of the method comprise:
a) receiving a plurality of measured pressure values of a fluid pressure in the fluid system measured at different points in time;
b) computing, from the received pressure values, a first pressure gradient indicative of a gradient of the measured pressure values at a first point in time;
c) computing, from the received pressure values, a second pressure gradient indicative of a gradient of the measured pressure values at a second point in time, later than the first point in time, wherein the fluid pressure in the fluid system at the first point in time is higher than the fluid pressure in the fluid system at the second point in time;
d) comparing the magnitude of the second pressure gradient, which second pressure gradient is indicative of the gradient of the measured pressure values at the second point in time, with the magnitude of the first pressure gradient, which first pressure gradient is indicative of the gradient of the measured pressure values at the first point in time, and detecting presence of leakage responsive to the magnitude of the second pressure gradient being smaller than the magnitude of the first pressure gradient.

Accordingly, the leakage detection is based on a comparison of two selected pressure gradients of the measured pressure values with one another, i.e. based on a comparison of selected two observed pressure gradients with one another, rather than e.g. a comparison of measured pressure values with a certain threshold. The two observed pressure gradients are selected such that they are observed pressure gradients at two different times and at different pressure levels, in particular during a period of decreasing pressure. The detection is based on the realization that, if the magnitude of the pressure gradient at the time where the pressure level is low is smaller than the magnitude of the corresponding pressure gradient at an earlier time where the pressure level was higher, this is indicative of the pressure drop occurring due to a persistent leakage rather than due to the start of an intended water usage, e.g. caused by a user opening a faucet. Accordingly, embodiments of the process disclosed herein detect/register an indication of the presence of a leakage when, in particular only when, the magnitude of the second observed pressure gradient is smaller than the magnitude of the first observed pressure gradient, i.e. the comparison of the selected two observed pressure gradients with each other is taken as an indicator of the presence of a leakage.

Generally, the pressure gradient is indicative of the slope of a pressure curve that represents the measured pressure as a function of time. The pressure gradient represents the derivative of the measured pressure with respect to time. The gradient represents the steepness and the direction of the change of the measured pressure, namely whether the pressure increases or decreases over time and at what rate. The magnitude of the pressure gradient represents the rate of the change, i.e. the steepness of the pressure curve when plotted as a function of time. The magnitude of the pressure gradient may be determined as the absolute value of the pressure gradient or as another positive quantity indicative of the numerical/absolute value of the pressure gradient irrespective of whether the pressure gradient is positive or negative, i.e. the magnitude of the pressure gradient is a positive number indicative of the rate of change of the measured pressure. In some embodiments, detecting a presence of leakage is responsive to the magnitude of the second pressure gradient being smaller than the magnitude of the first pressure gradient and the first and second pressure gradients both being smaller than zero.

Embodiments of the process can more reliably distinguish between the presence of persistent leakage and a short-term intended fluid consumption. Accordingly, embodiments of the process described herein provide a reliable detection of leakage while avoiding false positive alarms. At least some embodiments of the method disclosed herein may perform leakage detection based only on the measured pressure signal, i.e. without any need for additional input from other types of sensors, such as sensors for measuring fluid levels, flow rates, temperature, etc. Nevertheless, in some embodiments, additional input from one or more such sensors may be used to advantage.

Moreover, embodiments of the method disclosed herein is computationally efficient as it only requires the computation of the magnitudes of two pressure gradients and the comparison of these pressure gradients with one another.

The detected leakage may be caused by various types of leaks such as by an unintended hole, a crack, a joint not being sufficiently tight, a corroding wall of a conduit or vessel, and/or the like, through which fluid may escape from the fluid system.

In some embodiments, the fluid system comprises a pump configured to increase the fluid pressure in the fluid system, wherein the pump is controllable to selectively start and stop pump operation, and wherein the first point in time is selected to correspond to a stop of pump operation of the pump, in particular to a time subsequent to, i.e. later than, the stop of pump operation of the pump. The second point in time may be selected as a point in time corresponding to, in particular prior to, a start of pump operation of the pump and/or to a time of a detected increase in fluid pressure. In particular, the pump may be controlled responsive to measured pressure values, e.g. so as to maintain the fluid pressure within a predetermined target range. For example, the pump may be controlled to start pump operation responsive to the measured pressure falling below a lower threshold pressure and to stop pump operation responsive to the measured pressure increasing above a higher threshold pressure. To this end, the pump may comprise a pump control circuit or it may be controlled by an external pump control circuit separate from the pump. The measured pressure values used as a basis for the pump control may be pressure values measured by the same sensor used for the leakage detection disclosed herein, or they may be measured by a different pressure sensor.

More generally, according to one aspect, disclosed herein are embodiments of a method for detecting leakage in a fluid system, the fluid system comprising a pump configured to increase the fluid pressure in the fluid system, wherein the pump is controllable to selectively start and stop pump operation, wherein the method comprises:
a) receiving a plurality of measured pressure values of a fluid pressure in the fluid system measured at different points in time;
b) detecting a start time at which the pump starts a pump operation, and computing, from the received pressure values, a first pressure gradient indicative of a gradient of the measured pressure values at a first point in time prior to the detected start time;
c) detecting a stop time at which the pump stops a pump operation, the stop time being subsequent to the detected start time, and computing, from the received pressure values, a second pressure gradient indicative of a gradient of the measured pressure values at a second point in time subsequent to the detected stop time;
d) detecting presence of a leakage from at least a comparison of the computed first and second pressure gradients with each other.

In particular, the detected stop time may be the time at which the pump stops the pump operation that has started at the detected start time, i.e. the time of the earliest stop of the pump operation subsequent to the detected start time. The pump operation refers to the pump pumping fluid between an inlet and an outlet of the pump, in particular so as to increase the fluid pressure in the fluid system.

The stop of pump operation of the pump may e.g. be detected based on a stop signal received from the pump control circuit that controls operation of the pump. Alternatively, the stop of operation of the pump may be determined in another manner, e.g. by monitoring a drive current driving the pump motor or based on the measured pressure values, e.g. by detecting a transition from an increasing or stable pressure to a decreasing pressure, in particular a decreasing pressure having a gradient with a magnitude larger than a predetermined threshold.

The first point in time may be selected to correspond to, in particular subsequent to, the stop of operation in a number of ways, e.g. by selecting measured pressure values to be used for the computation of the first gradient to include measured pressure values that have been obtained immediately after the stop of pump operation of the pump, e.g. one or more measured pressure values having time stamps (in particular the earliest time stamps) later than the stop of operation. Alternatively, the first point in time may be selected to be a predetermined time interval after the stop of the pump operation, or to have another predetermined temporal relation to the stop of pump operation.

Accordingly, the leakage detection is performed based on pressure measurements at a point in time where the pump is not operating, i.e. the leakage detection is not influenced by the pressure changes induced by the pump. Moreover, the leakage detection may be based on a large pressure range, as the first pressure gradient is normally computed at or near a maximum pressure value.

In some embodiments, the second point in time is selected to correspond to, in particular prior to, a start of a pump operation of the pump and/or to a time of a detected increase in fluid pressure.

The start of a pump operation of the pump may e.g. be detected based on a start signal received from the pump control circuit that controls operation of the pump. Alternatively, the start of a pump operation may be determined in another manner, e.g. by monitoring a drive current driving the pump motor or based on the measured pressure values, e.g. by detecting a transition from a decreasing or stable pressure to an increasing pressure, in particular an increasing pressure having a gradient larger than a predetermined threshold.

The second point in time may be selected to correspond to, in particular prior to, the start of the pump operation in a number of ways, e.g. by selecting measured pressure values to be used for the computation of the second gradient to include measured pressure values that have been obtained immediately before the start of the pump operation, e.g. one or more measured pressure values having time stamps (in particular the latest time stamps) prior to the start of the pump operation or prior to the detected increase of the pressure. Alternatively, the second point in time may be selected to be a predetermined time interval before the start of the pump operation, or to have another predetermined temporal relation to the start of operation.

Accordingly, the leakage detection is performed based on pressure measurements at a point in time where the pump is not operating, i.e. the leakage detection is not influenced by the pressure changes induced by the pump. Moreover, the leakage detection may be based on a large pressure range, as the second pressure gradient is normally computed at or near a minimum pressure value.

In some embodiments, the method further comprises computing a current leakage rate and/or a current leakage amount. For the purpose of the present description, the term leakage rate refers to the amount of leakage per unit time, while the mount of leakage refers to the leaked volume, in particular, the volume leaked during a predetermined time interval. The leakage rate may be measured in m³/s while the leakage amount may be measured in m³. In particular, the current leakage rate may be computed at least from one of the first and second pressure gradients. In some embodiments, the current leakage rate is computed based on at least the first and second pressure gradients, e.g. based on an average of the first and second pressure gradients.

In some embodiments, a current leakage amount is computed, e.g. by computing at least an approximation of the integral over the pressure gradient between the first and second points in time, e.g. by multiplying the average of the first and second pressure gradients with the time interval between the first and second points in time.

In some embodiments, the computation of the current leakage amount further includes computation of an estimated leakage amount associated with a time period during which the pump operates, e.g. by further basing the computation of the current leakage amount on a previous start time of the pump, the previous start time preceding the first point in time. The current leakage amount for the time between two consecutive start times of the pump may thus be computed from the computed current leakage rate and from the time interval between the previous start time and the second point in time.

In some embodiments, the computation of the current leakage rate and/or the computation of the current leakage amount further includes compensating the computed current leakage amount and/or the current leakage rate responsive to one or more detected events, e.g. a detected temporary increase in pressure that may be caused by reasons other than operation of the pump, e.g. in mains boost or rain tank applications. For example, the supply pressure at the inlet of the pump may fluctuate and temporarily increase. Accordingly, in some embodiments, the method further comprises:
monitoring the fluid pressure during a time period between the first and second points in time,
responsive to detecting a temporary pressure increase during said time period, computing a modified current leakage rate and/or a modified current leakage amount to compensate for the detected temporary pressure increase.

The modified current leakage rate and/or the modified current leakage amount may be determined in a variety of ways. For example, the temporary pressure increase may be treated in the same manner as the start and stop of the pump operation. Accordingly, the time interval between the stop and subsequent start of the pump operation may be divided in multiple sub-intervals, including a first interval prior to the temporary pressure increase and a second time interval subsequent to the temporary pressure increase. The process may thus compute respective first and second current leakage rates for the first and second intervals, respectively. The process may further compute first and second current leakage amounts. The first current leakage amount may be associated with the interval between the previous start of the pump and the start of the detected temporary pressure increase. The second current leakage amount may be associated with the time period between the start of the detected temporary pressure increase and the second point in time, i.e. the subsequent start of the pump operation.

The process may detect a temporary pressure increase in a number of ways. The onset of a temporary pressure increase may be detected by a transition from a negative to a positive pressure gradient. Nevertheless, the process may use additional or alternative criteria for detecting a temporary pressure increase. For example, in some embodiments, only pressure increases larger than a predetermined minimum magnitude may be considered for the purpose of computing a modified current leakage rate, while small pressure increases may be disregarded. It will be appreciated that, in some embodiments, the process may even disregard all temporary pressure increases not associated with a start of the pump.

The end of a temporary pressure increase may be detected as a transition from a positive gradient, or from a gradient having a magnitude smaller than a predetermined threshold, to a negative pressure gradient having a magnitude larger than a predetermined threshold. Alternatively, the end of the temporary pressure increase may be detected in another way, e.g. as the point in time when the pressure again has fallen to the same value as at the detected onset of the temporary pressure increase.

Accordingly, in some embodiments, responsive to detecting a temporary pressure increase while the pump is not operating, the process may detect the duration of the temporary pressure increase. The duration may e.g. be determined between the onset/start of the temporary pressure increase until the point in time when the pressure again starts to fall or until the point in time when the pressure again has fallen to the same level as immediately prior to the onset of the temporary pressure increase. The process may then compute a base current leakage rate based on the first and second pressure gradients, compute a base current leakage amount from the base current leakage rate and based on the time interval between the first and second points in time reduced by the duration of the temporary increase. The thus computed base leakage amount may then be supplemented with an estimated leakage rate for the duration of the temporary pressure increase. The latter may be computed in the same manner as the estimated leakage rate computed for the time during which the pump is operating, i.e. assuming a constant leakage rate.

In some embodiments, e.g. when the process does not receive information about the start or stop of a pump, the process may determine the current leakage rate based on the measured pressure values alone. This may be the case in systems where the system pressure is partly or completely regulated other than by a pump of the system, e.g. in mains boost applications or rain tank applications. Even if the system includes a pump for regulating the system pressure, in some embodiments, the data processing system performing the leak detection may receive pressure readings from a pressure sensor without receiving information about the start and stop of the pump. Accordingly, in some embodiments, the process may monitor the measured pressure values and determine the first and second points in time from the monitored pressure values, in particular only from the monitored pressure values.

Accordingly, in some embodiments, the method further comprises:
monitoring the fluid pressure to detect at least one temporary pressure increase
selecting the first point in time as a time corresponding to, in particular subsequent to, a detected end of one of the detected at least one temporary pressure increase, and
selecting the second point in time as a time corresponding to, in particular prior to, a detected onset of one of the at least one detected temporary pressure increase.

In particular, in some embodiments, the method comprises:
monitoring the fluid pressure to detect at least a first temporary pressure increase and a second, subsequent temporary pressure increase, the second temporary pressure increase occurring subsequent to a detected end of the first temporary pressure increase,
selecting the first point in time as a time corresponding to, e.g. subsequent to, such as immediately following, the detected end of the first temporary pressure increase and selecting the second point in time as a time corresponding to, e.g. prior to, such as immediately preceding, a detected onset of the second temporary pressure increase.

For example, the process may determine the first point in time by detecting an onset of a decrease in pressure, e.g. a transition from an increasing pressure or from a substantially constant pressure to a decreasing pressure, e.g. by detecting a transition from a positive gradient or from a gradient that has a magnitude smaller than a threshold gradient to a negative gradient having a magnitude above a threshold gradient and/or by detecting a peak in a second derivative of the pressure curve, the peak having a predetermined minimum magnitude. The first point in time may be selected to correspond to the detected end of the temporary pressure increase in a number of ways, in particular such that it immediately follows the end of the temporary pressure increase, e.g. after a predetermined delay after the detected end of the temporary pressure increase.

Similarly, the process may determine the second point in time by detecting the onset of a temporary increase in pressure, in particular of a temporary pressure increase having at least a minimum magnitude and/or of a temporary pressure increase fulling another detecting criteria computed from the monitored pressure values. In particular, the process may select the second point in time such that it corresponds to the onset of a subsequent temporary pressure increase following a previous temporary pressure increase, the end of which is selected as the first point in time. The second point in time may correspond to the onset of a temporary pressure increase in a variety of ways, in particular such that it immediately precedes the temporary pressure increase, e.g. is selected at a predetermined short time interval prior to the detected onset of the pressure increase.

The, or each, thus detected temporary pressure increase and subsequent pressure decrease may be treated in the same manner as the start and stop of a pump operation. The process may thus compute respective first and second pressure gradients at the first and second points in time, respectively, and compute a current leakage rate and/or leakage amount for the time interval between the first and second points in time.

In some embodiments, the computation of the current leakage amount may further include computation of an estimated leakage amount associated with a time period of the duration of the temporary pressure increase, e.g. by further basing the computation of the current leakage amount on an increase of the pressure preceding the determined first point in time. The current leakage amount for the time between two consecutive points in time where the pressure increases may thus be computed from the computed current leakage rate and from the time interval between the start times of two consecutive pressure increases.

In some embodiments, the method comprises computation of an aggregated leakage rate and/or an aggregated leakage amount. For example, the process may compute an average leakage rate, based on a plurality of current leakage rates computed for respective start/stop cycles of the pump, e.g. based on monitored pressure values obtained over an extended period of time, e.g. one or more days or even one or more weeks. The average leakage rate may be a weighted average over multiple current leakage rates, each current leakage rates weighted by the respective time interval for which said current leakage rate has been computed. In particular, the method may comprise:
repeating at least steps b) through e) in respect of respective time intervals between respective first and second points in time to compute respective current leakage rates associated with respective time intervals,
computing an aggregated leakage rate from the respective current leakage rates.

In particular, the respective time intervals may be non-overlapping time intervals. Accordingly, the process may repeat, in particular, continuously repeat at least steps b) through e) for a plurality of time intervals where each time interval is defined from where the pump stops operation to where the pump starts operation, in particular to the next start of pump operation following the stop of pump operation.

Generally, the pump and/or data processing system may perform one or more actions responsive to a detected leakage alarm. Examples of such actions include:
Issuing a leakage notification.
Closing a valve, e.g. at an inlet to the fluid system, so as to stop or reduce fluid supply.
Controlling the pump to reduce the target pressure in the fluid system so as to reduce the amount of leaked fluid.

The choice of actions may be pre-configured. In some embodiments the choice of action may depend on the computed leakage rate.

In some embodiments, the method comprises issuing a notification to a user responsive to or more of the current leakage rate, the current leakage amount, the aggregate leakage rate and the aggregate leakage amount fulfil a predetermined condition, e.g. when the one of the monitored leakage rates or amounts exceeds an alert threshold. It will be appreciated that such notifications may have different severity levels, e.g. responsive to the current or aggregate leakage rate/amount exceeding respective alert levels. In addition to, or instead of, issuing notifications, the method may log or display the computed current and/or aggregate leakage rate and/or amount, and/or communicate the computed leakage rates or amounts an external data processing device for logging, display and/or further processing.

The present disclosure relates to different aspects including the method described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, embodiments of the method disclosed herein may be computer-implemented. Accordingly, disclosed herein are embodiments of a data processing system configured to perform the steps of the method described herein. In particular, the data processing system may have stored thereon program code adapted to cause, when executed by the data processing system, the data processing system to perform the steps of the method described herein. The data processing system may be embodied as a single computer or other data processing device, or as a distributed system including multiple computers and/or other data processing devices, e.g. a client-server system, a cloud based system, etc. The data processing system may include a data storage device for storing the computer program and sensor data. The data processing system may include a communications interface for receiving measured pressure values and/or other types of sensor data. In some embodiments, the data processing system may partly or completely be embodied as a suitably programmed or otherwise configured processing unit, e.g. a pump controller, for controlling operation of a pump comprised in the fluid system. Accordingly, a part of the data processing system or the whole data processing system may be accommodated in a housing of the pump. Alternatively or additionally, the data processing system may include one or more data processing apparatus external to the pump. The data processing system may receive pressure values, e.g. in digital form or as an analogue pressure signal, from a pressure sensor as input to the leakage detection process. The pressure sensor may be positioned at a suitable position within the fluid system and configured to measure a fluid pressure of the fluid system. In some embodiments, the pressure sensor is integrated into the pump. In embodiments where the pressure sensor is arranged externally to the data processing system, the data processing system may receive the pressure values from the external pressure sensor via a suitable wired or wireless communicative connection, e.g. directly from the pressure sensor or indirectly via one or more intermediate nodes.

Accordingly, according to one aspect, disclosed herein are embodiments of a pump for use in a fluid system, the pump comprising a processing unit configured to control operation of the pump; wherein the processing unit is further configured to perform the steps of the method described herein. The pump may comprise one or more fluid-moving components and a pump motor configured to drive the one or more fluid-moving components of the pump. The pump may further comprise a control circuit controlling the pump motor. The processing unit of the pump may be separate from, or integrated into the control circuit of the pump, e.g. into a control circuit controlling the pump motor. Accordingly, the control circuit or a separate processing unit of the pump may be suitably programmed to perform an embodiment of the process described herein, either alone as a stand-alone device or as part of a distributed data processing system, e.g. in cooperation with an external data processing system such as with a portable data processing device and/or with a remote host computer and/or with a cloud-based architecture. The pump may further include an integrated pressure sensor configured to measure a pressure of the fluid being pumped. The processing unit may thus receive measured pressure values from the integrated pressure sensor as input to the leakage detection process. Alternatively, the pump may receive measured pressure values from an external pressure sensor, external to the pump, as input to the leakage detection process. The external pressure sensor may be positioned at a suitable position within the fluid system and configured to measure a system pressure of the fluid system. The processing unit may receive the measured pressure values from the external pressure sensor via a suitable wired or wireless communicative connection.

In some embodiments, the pump comprises a communications interface for wired or wireless communication with a remote data processing system. For example, the communications interface may be a wireless interface, e.g. using Wifi, Bluetooth or another suitable wireless communications technology. In some embodiments, the pump may communicate directly with a user device, e.g. a suitably programmed personal computer, tablet or smartphone. Such communication may e.g. utilize Bluetooth or another short-range communications technology. In some embodiments, the pump may communicate with a remote data processing system via the internet, e.g. via a suitable router or another gateway device to which the pump may be connectable via a local wired or wireless connection, e.g. via a network cable, wifi, Bluetooth or the like. The remote data processing system may be a server computer, a cloud computing platform and/or the like. The remote data processing system may allow users to view and/or input data pertaining to the leakage detection via a suitable user device, such as a suitably programmed personal computer, a tablet, a smartphone or the like, which may be communicatively coupled to the remote data processing system via the internet or via another suitable computer or communications network.

The pump may be configured to communicate data pertaining to the leakage detection with the remote data processing system via the communications interface. Examples of such data include measured pressure values and/or computed leakage rates and/or amounts, which the pump may communicate to the remote data processing system. Other examples of such data include configuration data, such as alert thresholds, which the pump may receive from the remote data processing system.

Accordingly, the remote data processing system may perform some or all of the computational steps for the leakage detection. Regardless of whether the remote data processing system performs part of the leakage detection, the remote data processing system may provide a user-interface for allowing a user to monitor the pressure values and/or computed leakage rates and/or amounts. The remote data processing system may also issue warnings or alerts or other notifications responsive to detected leakage conditions, e.g. audible or visual alerts, alerts communicated via e-mail, SMS, or other forms of notifications, and/or the like.

The remote data processing system may also provide a user-interface allowing a user to set one or more configuration parameters pertaining to the leakage detection, e.g. to set one or more alert thresholds as to when the system should issue an alert.

It will be appreciated that, in some embodiments, the pump itself may provide a user interface for viewing results of the leakage detection and/or for setting configuration parameters. Hence, in some embodiments, a remote data processing system may be omitted or it may be provided in addition to a user-interface of the pump.

According to yet another aspect, a fluid system comprises a pressure sensor and a data processing system communicatively coupled to the pressure sensor; wherein the data processing system is configured to perform the steps of the method described herein. In some embodiments, the fluid system comprises a fluid inlet for supplying fluid to the fluid system and a one-way valve configured to prevent reverse fluid flow through the inlet. In some embodiments, the one-way valve may be integrated into the pump. As described herein, the data processing system may be embodied as a remote data processing system, which may be communicatively coupled to the pump and/or the pressure sensor. Alternatively, the data processing system may be embodied as an internal data processing unit of a pump.

Yet another aspect disclosed herein relates to embodiments of a computer program configured to cause a data processing system to perform the acts of the method described above and in the following. A computer program may comprise program code means adapted to cause a data processing system to perform the acts of the method disclosed above and in the following when the program code means are executed on the data processing system. The computer program may be stored on a computer-readable storage medium, in particular a non-transient storage medium, or embodied as a data signal. The non-transient storage medium may comprise any suitable circuitry or device for storing data, such as a RAM, a ROM, an EPROM, EEPROM, flash memory, magnetic or optical storage device, such as a CD ROM, a DVD, a hard disk, and/or the like.

### BRIEF DESCRIPTION OF THE DRAWINGS

Preferred embodiments will be described in more detail in connection with the appended drawings, where

FIG. 1 schematically shows an embodiment of a fluid system.

FIG. 2 schematically shows another embodiment of a fluid system.

FIG. 3 shows an example of measured pressure values in a fluid system.

FIG. 4 schematically shows a flow diagram of a method for detecting leakage in a fluid system.

FIG. 5 schematically shows a flow diagram of another method for detecting leakage in a fluid system.

FIG. 6 shows an example of the results of an example of the leakage computation described herein.

### DETAILED DESCRIPTION

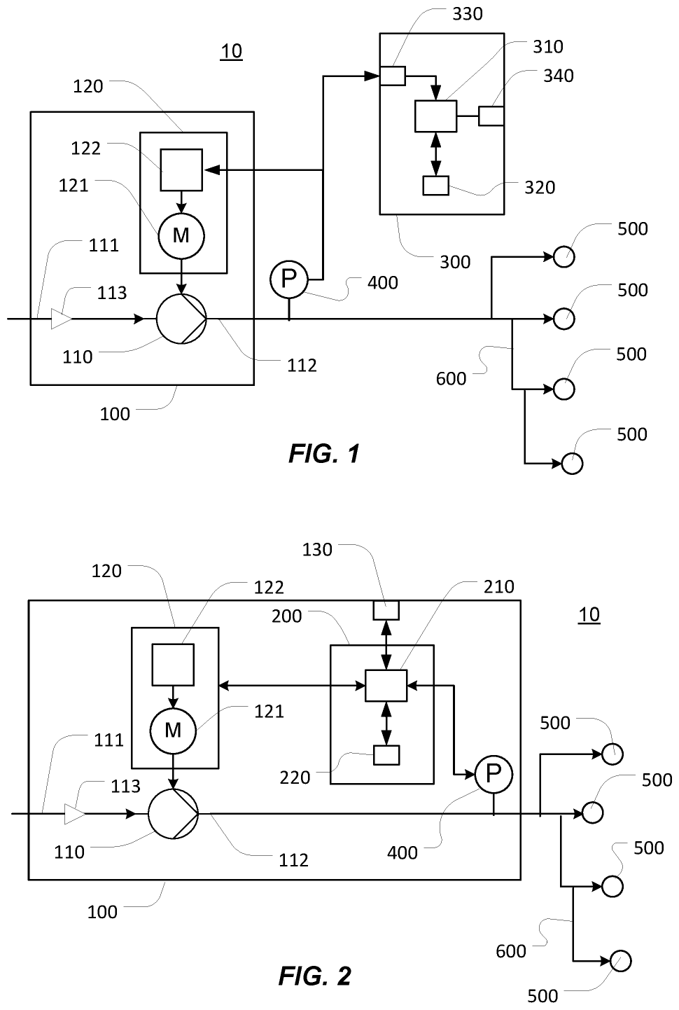

FIG. 1 schematically shows an embodiment of a fluid system, generally designated by reference numeral 10. The fluid system 10 is configured to distribute a fluid, such as a liquid, e.g. water, from a fluid supply inlet 111 to one or more fluid dispensing points 500 through one or more fluid conduits 600, in particular through one or more pipes. The system 10 comprises a pump 100 and/or other apparatus for moving the fluid and, in particular, configured to adjust, in particular increase, the fluid pressure in the fluid system.

For example, the pump 100 may be operable to maintain the fluid pressure in the fluid system within a predetermined range. For example, the pump may be operable as a so-called booster pump that is operable to maintain a target pressure in the fluid system even if the supply pressure at the inlet 111 is lower or unstable. The pump may also be operable as a well pump configured to pump fluid from a well or other fluid reservoir so as to maintain a target pressure or target pressure range in the fluid system.

The fluid system may be a residential or commercial water supply system. Accordingly, the dispensing points 500 may be fitted with faucets or other plumbing fixtures allowing selective dispensing of water.

The pump 100 comprises a fluid displacement mechanism 110 and a pump drive 120. The fluid displacement mechanism 110 may be a centrifugal pump mechanism or a different type of pump mechanism. The fluid displacement mechanism 110 has an inlet 111 for receipt of the fluid. The fluid displacement mechanism 110 also has an outlet 112 for providing the output flow of the pump. The pump drive 120 comprises a motor 121, such as an electrical motor, and a pump control circuit 122. The pump control circuit may include a frequency converter for supplying the motor with electrical energy and/or other circuitry for controlling operation of the motor 121. The pump control circuit may be connectable to a suitable power supply (not shown) in order to supply the drive circuit, e.g. a frequency converter, with electric energy. During operation, the motor 121 causes the fluid displacement mechanism 110 to pump fluid from the inlet 111 to the outlet 112. It will be appreciated that other embodiments of a fluid system may include a different type of pump and/or additional pumps.

The pump 100 further comprises a one-way valve 113 configured to prevent return flow of fluid from the fluid system through the inlet 111. While shown as directly connected to the inlet 111 of the pump, it will be appreciated that alternative embodiments of the pump may include a one-way valve at a different location, e.g. at the outlet 112. Yet further, in alternative embodiments of the fluid system, at separate one-way valve not integrated into the pump may be used. For example, such one-way-valve may be located at the conduit connected to the inlet 111 or at the conduit connected to the outlet 112 of the pump, preferably upstream from the pressure sensor 400 described below.

The fluid system may further include additional components, such as pipes, valves, fluid reservoirs, pumps, sensors, boilers, return conduits, etc. Some or all of the additional components may be directly or indirectly operationally coupled to the pump 100, e.g. be in fluid communication with the pump 100.

The fluid system further comprises a pressure sensor 400 configured to measure a fluid pressure of the fluid in the fluid system 10, or otherwise a pressure indicative of the pressure of the fluid in the system. While shown as a separate component in FIG. 1, it will be appreciated that, in some embodiments, the pressure sensor may be integrated with the pump or with another component of the fluid system, e.g. a valve. It will be appreciated that some embodiments of a fluid system may include multiple pressure sensors.

The fluid system of FIG. 1 further comprises a data processing system 300. The data processing system 300 may be a suitably programmed computer or other data processing device. In some embodiments, the data processing system 300 may be a distributed system including more than one computer. For example, the data processing system may be a control system configured to control the fluid system or it may be another type of local or remote data processing system. The data processing system 300 is communicatively coupled to the pressure sensor 400, e.g. via a wired or wireless connection, and configured to receive measured pressure values from the pressure sensor, e.g. continuously, quasi-continuously, or intermittently, such as periodically. The communication between the pressure sensor 400 and the data processing system 300 may be a direct communication or an indirect communication, e.g. via one or more nodes of a communications network. Examples of a wired connection include a local area network, a serial communications link, etc. Examples of wireless connections include a radio frequency communications link, e.g. Wifi, Bluetooth, cellular communication, etc. In some embodiments, communication between the pressure sensor 400 and the data processing system may be via the internet. To this end, the pressure sensor 400 may be an IoT enabled sensor and/or the pressure sensor 400 may be connected to a local gateway device, which in turn is configured to communicate with the data processing system 300.

The data processing system 300 comprises a suitably programmed processing unit 310, such as a CPU, and a memory 320. The memory has stored thereon a computer program and/or data for use by the processing unit 310.

Optionally, the data processing system 300 comprises a user-interface 340, e.g. including a graphical user-interface displayed on a display of the data processing system such as on a touch screen.

The data processing system 300 may receive measured pressure values from the pressure sensor 400, either continuously or intermittently, e.g. periodically, e.g. such that the data processing system receives a time series of measured pressure values indicative of a pressure of the fluid at different points in time. To this end, the data processing system has a suitable interface 330 for receiving measured pressure values. In some embodiments, the data processing system, or an intermediary device, may receive an analogue pressure signal and include suitable signal processing circuitry, e.g. including an analogue-to-digital converter, to convert the analogue pressure signal in a time series of digital pressure values. The pressure sensor 400 or an intermediary device may transmit the measured pressure values automatically or upon request from the data processing system. Each pressure value may be associated with a time stamp. Alternatively or additionally, the measured pressure values may represent pressure values sampled at a sampling rate, in particular at a constant sampling rate. The data processing system 300 may further receive additional data from the fluid system.

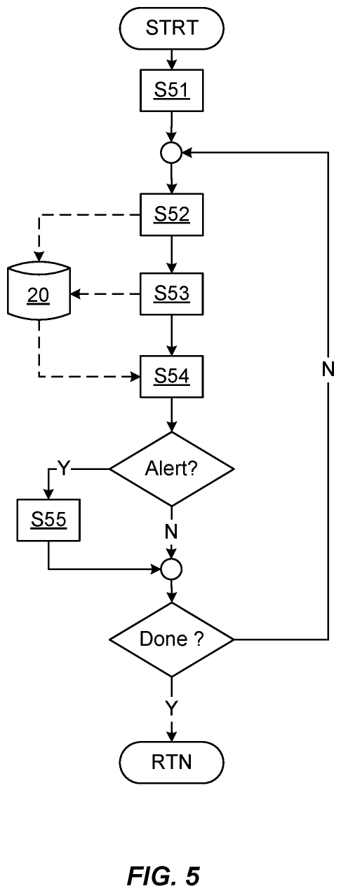

The processing unit 310 is programmed to perform a leakage detection process as described herein, e.g. the leakage detection process described in connection with any of FIGS. 4-5 below. Upon detection of leakage, the data processing system 300 may output an alarm or other suitable notification via the user-interface 340. Alternatively or additionally, the data processing system may send a leakage alarm or warning and/or other types of events to a component of the fluid system e.g. to the pump 100, to a local control system (not shown) and/or the like. An example of a leakage detection process that can be performed by the processing unit 310 will be described in more detail below.

The pressure sensor 400 may further be communicatively connected to the pump control circuit 122 or to an external control unit (not shown) configured for controlling operation of the pump 100. To this end, the pressure sensor 400 may be connected to the pump control circuit 122 via a suitable wired or wireless interface, e.g. via a direct wired communications link, via a wired or wireless local network and/or the like.

Accordingly, the pump control circuit 122 or the external control unit may be configured to control operation of the pump responsive to the measured fluid pressure in the fluid system. This allows the pump to be operated as a booster pump or well pump. For example, the pump control circuit or the external control unit may be configured to control operation of the pump so as to maintain the liquid pressure above a predetermined lower pressure threshold and/or within a target pressure range. In particular, the pump control circuit or the external control unit may be configured to cause the pump to start operation when the measured fluid pressure falls below a lower threshold. The pump control circuit or the external control unit may further be configured to cause the pump to stop operation when the measure liquid pressure exceeds an upper threshold or exceeds the upper threshold for at least a minimum period of time. Alternatively, other pump control strategies may be employed, such as other pressure-based control strategies.

FIG. 2 schematically illustrates another example of a fluid system 10. The fluid system of FIG. 2 is similar to the system of FIG. 1 in that it also comprises a pump 100, fluid conduits 600, fluid dispensing points 500, a pressure sensor 400 and, optionally, other components and/or the like, all as described in connection with FIG. 1. The fluid system of FIG. 2 differs from the system of FIG. 1 in that the pump 100 includes the pressure sensor 400 and a data processing system in the form of a data processing unit 200 integrated into the pump 100, e.g. arranged within a pump housing of the pump 100. The pump 100 further includes a fluid displacement mechanism 110 and a pump drive 120 as described in connection with FIG. 1. The data processing unit 200 and the pressure sensor 400 may be accommodated into the same housing as the pump drive 120. The data processing unit 200 comprises a suitably programmed processing unit 210, such as a CPU, a microcontroller, a microprocessor, or the like, and a memory 220.

The memory may have stored thereon a computer program and/or data for use by the processing unit 210.

The data processing unit 200 may receive measured pressure values, e.g. in the form of an analogue or digital pressure signal indicative of measured pressure values, from the pressure sensor 400, either continuously or intermittently, e.g. periodically, e.g. such that the data processing unit 200 receives a time series of measured pressure values indicative of a pressure of the fluid at different points in time. The pressure sensor 400 or an intermediary device may transmit the measured pressure signal automatically or upon request from the data processing unit. Each pressure value may be associated with a time stamp. The data processing unit 200 may further receive additional data from the fluid system. If the pressure sensor 400 is internal to the pump, as shown in FIG. 2, the data processing unit 200 may receive the pressure signal via an internal interface, e.g. a data bus. In other embodiments, the pressure sensor may be external to the pump 100. In that case, the data processing unit 200 may receive the measured pressure signal via another suitable wired or wireless interface, e.g. via a direct wired communications link, via a wired or wireless local network and/or the like. For example, the pressure sensor may be integrated into or otherwise connected to another component of the fluid system, such as a valve, an expansion vessel, etc.

The processing unit 210 is programmed to perform a leakage detection process as described herein, e.g. the leakage detection process described in connection with any one of FIGS. 4-5 below. Upon detection of leakage and/or upon occurrence of another event, the data processing unit 200 may output an alarm or other suitable notification, e.g. via a user-interface of the pump, e.g. by activating a visible or audible alarm indicator. To this end, even though not explicitly shown in the embodiment of FIG. 2, it will be appreciated that the pump 100 may include a user-interface as described in connection with FIG. 1. Alternatively or additionally, the data processing unit 200 may send a leakage alarm or warning and/or other types of events to another component of the fluid system, e.g. to a local control system (not shown), and/or to an external data processing system (not shown). To this end, the pump may comprise a communications interface 130 for wired or wireless communication with a remote data processing system, e.g. using Wifi, Bluetooth, a network cable and/or another suitable technology. The remote data processing system may be a user device, a server computer, a cloud computing platform and/or the like. The pump may be configured to communicate measured pressure values and or computed leakage rates and/or amounts to the remote data processing system. Alternatively or additionally, the pump may be configured to receive configuration data from the remote data processing system.

An example of a leakage detection process that can be performed by the processing unit 210 will be described in more detail below.

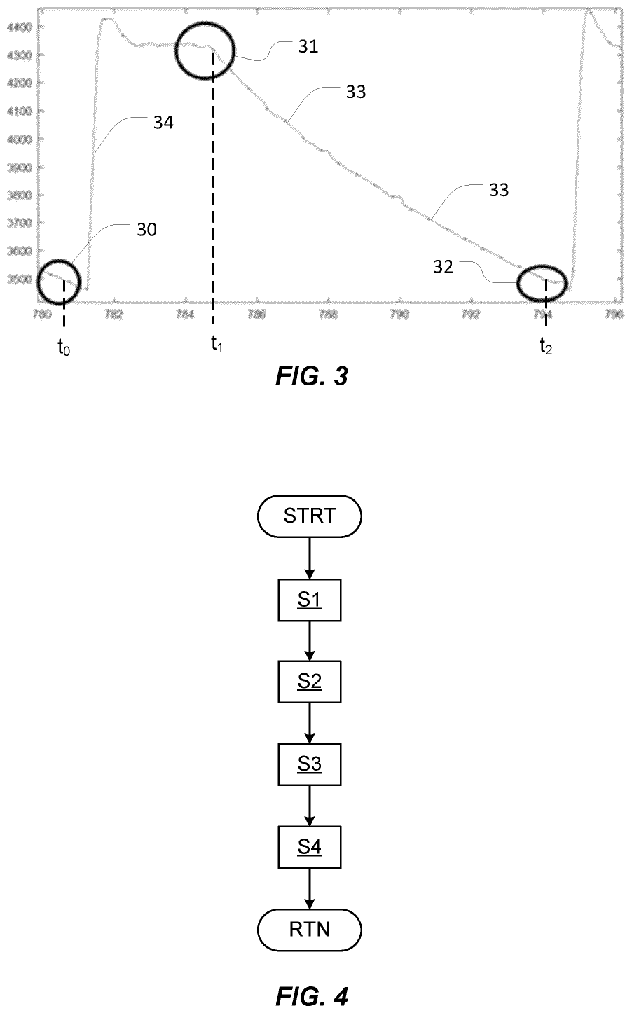

FIG. 3 shows an example of measured pressure values in a fluid system, e.g. a fluid system as illustrated in FIG. 1 or 2, in particular in a water-supply system including a pump that is controlled to selectively start and stop operation so as to maintain the fluid pressure in the fluid system above a lower threshold.

In particular, FIG. 3 shows dots representing measured pressure values 33, measured at different times. In the example of FIG. 3 measured pressure values are received at a fixed rate. In the example of FIG. 3, the sampling rate was 2 Hz. However, it will be appreciated that in other embodiments, the pressure sensors may provide measured values at a different rate, e.g. depending on factors such as the type of sensor, the bandwidth of the communication channel, the desired temporal resolution of the pressure monitoring etc. FIG. 3 further shows an interpolating curve 34 representing the fluid pressure as a function of time.

In the example of FIG. 3, the pump of the fluid system is configured to start pumping when the fluid pressure falls below a predetermined lower threshold, e.g. as indicated by the circle 30 at time to in FIG. 3. In this example, the lower threshold is about 3500 mbar. However, it will be appreciated that a different lower threshold may be selected, depending on the specific application and user preferences. In the example of FIG. 3, the pump is further configured to increase the fluid pressure to a predetermined target pressure and to maintain the fluid pressure at that target pressure. When the target pressure is maintained at the predetermined target pressure for a predetermined period of time, e.g. for a few seconds, the pump is configured to stop operation, e.g. as illustrated by the circle 31 at stop time t₁ in FIG. 3. In the present example, the target pressure is about 4300 mbar. However, it will be appreciated that a different target pressure may be selected, depending on the specific application and user preferences. Similarly, different pressure control strategies may be employed.

If the fluid system has no leak and if no fluid is intentionally withdrawn from the system, e.g. at one of a number of fluid dispensing points of the system, the fluid pressure would remain constant at the target pressure even after the pump has stopped its pump operation. If leakage occurs or if fluid is intentionally withdrawn from the system during use of the system, the pressure falls, e.g. as illustrated between the points in time t₁ and t₂ in FIG. 3. The rate of the pressure decrease, i.e. the magnitude of the gradient of the pressure curve, depends on the rate at which fluid is extracted from or escapes the fluid system. Accordingly, if the pressure decrease is due to leakage, the rate of pressure decrease depends on the size of the leak. Once the pressure again falls below the lower threshold, e.g. as illustrated by circle 32 at time t₂ in FIG. 3, the pump starts operating again so as to increase the pressure to the target pressure as described above. Accordingly, the pressure curve has a saw-tooth type of shape.

In the example of FIG. 3, the time between two consecutive starts of the pump was about 14 seconds. However, it will be appreciated that the interval between pump starts in a fluid system may vary from seconds to days or even weeks. This may depend on factors such as the nature of the fluid system, the type of pump, the control strategy of the pump and, in particular, on the size of the leak. It is an advantage of embodiments of the method disclosed herein that it allows detection of leaks of different sizes and over very different time scales. In particular, the method disclosed herein does not rely on any time windows of predetermined length.

FIG. 4 shows a flow diagram of an embodiment of a leakage detection process for detection of leakage in a fluid system, e.g. a system as described in connection with FIG. 1 or 2 above. To this end, the process receives a time series of measured pressure values. The pressure values may be measured by a pressure senor of the fluid system and are indicative of a fluid pressure of the fluid system.

In initial step S1, the process receives measured pressure values of a pressure in the fluid system measured at different points in time. The received pressure values may represent pressure values measured at a constant sampling rate or at a varying sampling rate. The process may receive the measured pressure values one at a time, e.g. in real time or quasi real-time, as the pressure values are measured. Alternatively, the process may receive an entire time series of previously measured pressure values. For the purpose of the following description, the pressure values will be denoted pₖ, k=1, . . . , N. For simplicity, it will be assumed that the pressure values are measured at a constant sampling rate, i.e. such that the time difference between the measurement of pₖ and pₖ₊₁ is Δtₖ=Δt=constant for all k. However, it will be appreciated that the case of varying sampling rate may easily be treated, e.g. by associating a time stamp tₖ to each measured pressure value pₖ, such that the time between the measurement of two pressure values may easily be computed.

In step S2, the process computes, from the received pressure values, a first pressure gradient at a first point in time. To this end, the process may initially determine the first point in time. Preferably, the process selects the first point in time such that the first point in time corresponds to a stop of operation of the pump, e.g. stop time t₁ illustrated in the example of FIG. 3. In particular, the process may determine a stop time of the pump. To this end, the process may receive a stop signal from the pump control circuit, the stop signal being indicative of the pump stopping operation. Alternatively, the process may detect the stop of the pump operation in another manner, e.g. by measuring a drive current of the pump, a magnetic field of the pump motor, or from the received pressure values. For example, the process may detect a transition from an increasing or stable pressure to a decrease in pressure, e.g. as indicated by circle 31 in FIG. 3. Such a transition may be detected from the received pressure values, e.g. by computing and monitoring a pressure gradient and detecting a transition from a positive gradient to a negative gradient, or by detecting a transition from a pressure plateau to a decreasing pressure. To this end, a pressure plateau may be detected as the pressure gradient having an absolute value smaller than a predetermined threshold for at least a predetermined time interval, and a decreasing pressure may be detected as a negative pressure gradient, or as a negative pressure gradient having a least a predetermined minimum absolute value.

Generally, the pressure gradient may be computed from the received pressure values in any suitable manner, e.g. based on two or more, such as based on three or four, consecutive pressure values. For example, the gradient at time t₁ (or at a first point in time shortly/immediately after t₁) may be estimated from the earliest two or more consecutive pressure values immediately after t₁, e.g. from the set {pₖ_{₁}, . . . , pₖ_{₁}_{+K}} for a suitable K>0 (e.g. K=1 or K=2 or K=3) and such that the time tₖ_{₁} at which pₖ_{₁} was measured is later than t₁, e.g. such that tₖ_{₁}₋₁≤t₁<tₖ_{₁}.

Hence, the pressure gradient at the first point in time may be computed as \dot{p}ₖ_{₁}=(pₖ_{₁}₊₁−pₖ_{₁})/Δt or in another suitable manner such that the pressure gradient is indicative of the gradient of the pressure curve at the first point in time, in particular at a point in time shortly after the stop of the pump operation.

In step S3, the process computes, from the received pressure values, a second pressure gradient at a second point in time, later than the first point in time. While shown as being subsequent to step S2 in FIG. 4, it will be appreciated that step S3 does not need to be performed after step S2 but may be performed before or concurrently with step S2 when the measured values at both points in time have been received. Nevertheless, the computed second pressure gradient is indicative of the gradient of the pressure curve at a second point in time, which is later than the first point in time.

To this end, the process may initially determine the second point in time. Preferably, the process selects the second point in time such that the second point in time corresponds to a start of operation of the pump, in particular to the earliest start of the pump operation after the first point in time, e.g. start time t₂ illustrated in the example of FIG. 3. In particular, the process may determine a start time of the pump. To this end, the process may receive a start signal from the pump control circuit, the start signal being indicative of the pump starting operation. Alternatively, the process may detect the start of the pump in another manner, e.g. by measuring a drive current of the pump, a magnetic field of the pump motor, or from the received pressure values. For example, the process may detect a transition from a stable or decreasing pressure to a rapid increase of the pressure values, e.g. by detecting a positive pressure gradient larger than a suitable threshold following a negative or substantially zero pressure gradient, e.g. as indicated by circle 32 of FIG. 3.

The gradient at (or shortly/immediately before) time t₂ may be estimated from the latest two or more consecutive pressure values immediately preceding t₂, e.g. from the set {pₖ_{₂}_{-K}, . . . , pₖ_{₂}} for a suitable K>0 (e.g. K=1 or K=2 or K=3) and such that the time tₖ_{₂} at which pₖ_{₂} was measured is earlier than t₂, e.g. such that tₖ_{₂}<t₂≤tₖ_{₂}₊₁.

Hence, the pressure gradient at the second point in time may be computed as \dot{p}ₖ_{₂}=(pₖ_{₂}₋₁−pₖ_{₂})/Δt or in another suitable manner such that the second pressure gradient is indicative of the gradient of the pressure curve at the second point in time, in particular at a point in time shortly before the start of the pump operation.

Determining the first and second points in time so as to correspond with the stop and start of the pump conveniently ensures that the pressure values at the first point in time are higher than at the second point in time and that the pressure curve between the first and second points in time is not affected by the operation of the pump. Moreover, by selecting the first point in time to be shortly after the stop of the pump operation and the second point in time to be shortly before the subsequent start of the pump operation, the estimation interval for the leakage detection is relatively long, this allowing for an accurate leakage detection and an accurate determination of the leakage rate and/or amount. However, it will be appreciated that, in other embodiments, the first and second points in time may be selected in a different manner, such that the pressure value at the first point in time is higher than the pressure value at the second point in time and such that the second point in time is later than the first point in time.

At step S4, the process detects whether leakage is likely occurring in the fluid system. To this end, the process compares that computed first and second pressure gradients with each other. If the magnitude of the second pressure gradient—e.g. as determined by the absolute value of the second pressure gradient—is smaller than the magnitude of the first pressure gradient—e.g. as determined by the absolute value of the first pressure gradient—the process determines that a leakage is present or at least is likely to be present. In particular, the magnitude of the second pressure gradient being smaller than the magnitude of the first pressure gradient is an indication of a pressure curve that is decreasing but with a decreasing rate. This is indicative of the decrease in pressure being caused by fluid exiting the fluid system through an opening of substantially constant or only slowly varying size. If, on the other hand, the second pressure gradient has a magnitude larger than the magnitude of the first pressure gradient, this is indicative of fluid exiting the fluid system through a newly created opening, e.g. due a user opening one of the fluid dispensing points.

FIG. 5 schematically shows a flow diagram of another method for detecting leakage in a fluid system. The process may be performed by a data processing system or by a data processing unit associated with a fluid system, e.g. by the data processing system 300 of the fluid system of FIG. 1 or by the data processing unit 200 of the fluid system of FIG. 2.

The process starts with an initialization step S51, where the process initialises various variables, counters, parameters and/or the like. For example, the process may set one or more threshold values for use in the leakage detection and/or for use in the alert generation. The parameters may be initialised to default values, pre-programmed values and/or user-selected values. The process further starts to receive measured pressure values obtained by a pressure sensor of the fluid system and, optionally, start/stop signals from a pump of the fluid system.

In step S52 the process performs leakage detection for a current time interval between a stop and subsequent start of the pump operation, e.g. by performing the steps of the method described in connection with FIG. 4. Generally, the process receives a plurality of measured pressure values of a fluid pressure in the fluid system measured at different points in time. The process computes, from the received pressure values, a first pressure gradient at a first point in time. The process also computes, from the received pressure values, a second pressure gradient at a second point in time, later than the first point in time. The fluid pressure in the fluid system at the first point in time may be higher than the fluid pressure in the fluid system at the second point in time. The process then detects the presence of a leakage, in particular responsive to the magnitude of the second pressure gradient being smaller than the magnitude of the first pressure gradient. The process may log the determined start and stop times of the pump operation and the received pressure values in a memory 20 or other data storage device, e.g. in the memory 320 of the system of FIG. 1 or the memory 220 of the system of FIG. 2.

At step S53, the process computes a current leakage rate for the current time interval. If no leak was detected the current leakage rate may be set to zero. If the process has detected leakage in previous step S52, the process may compute the leakage rate from at least the received pressure values. For example, the process may compute the current leakage rate at least from one of the first and second pressure gradients. In particular, the process may determine the current leakage rate between the stop of the pump operation at stop time t₁ and the subsequent start of the pump operation at start time t₂ as

$${L}_{12} = \frac{1}{2} ( {\dot{p}}_{{k}_{2}} + {\dot{p}}_{{k}_{1}} ) .$$

Similarly, the process may compute the current leakage amount between the previous start of the pump at previous start time to and the subsequent start of the pump at t₂ as

$${V}_{02} = {L}_{12} ( {t}_{2} - {t}_{0} ) .$$

Alternatively, the process may compute the current leakage amount in another suitable manner, e.g. by computing an approximation of the integral over the pressure gradient or from the difference in measured pressure values. For example, the process may compute an approximation of the current leakage amount V₁₂ during the time interval between the stop of the pump operation at t₁ and the subsequent start of the pump at t₂, e.g. by computing an approximation of the integral over the pressure gradient or by multiplying the current leakage rate L₁₂ with the time interval (t₂−t₁). The process may then compute a current leakage amount for the period between two successive starts of the pump, i.e. for the period between t₀ and t₂ as V₀₂=V₁₂(t₂−t₀)/(t₂−t₁).

At step S54, the process computes an aggregated leakage rate for a predetermined time period, e.g. as a weighted average of current leakage rates computed for multiple time intervals, e.g. as

$$\overline{L} = \frac{{\sum }_{i = 0}^{N} {L}_{2 i + 1 , 2 i} ( {t}_{2 i + 2} - {t}_{2 i} )}{{\sum }_{i = 0}^{N} ( {t}_{2 i + 2} - {t}_{2 i} )}$$

The aggregated leakage rate may be computed for successive time periods e.g. on a weekly basis, as a sliding window or in another suitable manner. The process logs and/or displays the computed current leakage rate and/or the aggregated leakage rate or another suitable quantity derivable from the current leakage rate and/or the aggregated leakage rate.

Based on the current leakage rate and/or the aggregated leakage rate, the process determines whether or not to issue an alert. For example, the process may issue an alert if the current leakage rate exceeds a predetermined alert threshold and/or if the aggregated leakage rate exceeds a predetermined alert threshold. If the process determines that a leakage rate should be issued the process proceeds at step S55; otherwise the process proceeds at step S56.

At step S55, the process issues a leakage alert, e.g. as a visible or audible alarm.

In any event, if further pressure data is available, the process returns to step S52 to continue the leakage detection for a subsequent time interval as the new current time interval.

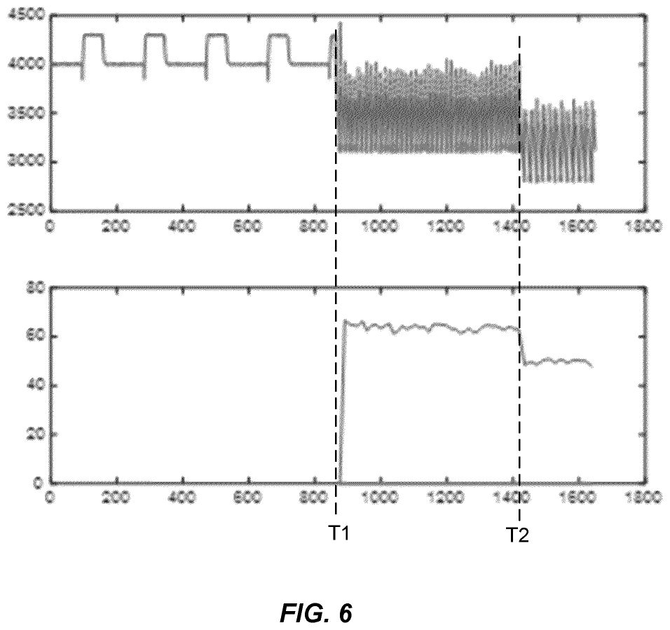

FIG. 6 shows an example of the results of the leakage computation described herein. The results are based on pressure measurements of a pump connected to a small needle valve followed in series with a capillary tube of 32 m, thus resulting in a controllable water flow, due to the constant tube resistance. The upper graph shows the measured pressure values over time and the lower graph shows computed current leakage rates over time. In the example of FIG. 6, a leak was simulated to occur at time T1. The pump controller was configured to reduce the target pressure of the system responsive to a detected leak having persisted for a predetermined period of time. Accordingly, in the example of FIG. 6, at time T2, the pump reduced the target pressure of the system, which resulted in a smaller leakage rate, which in turn was detected by the leakage detection process.

Embodiments of the method described herein may be computer-implemented. In particular, embodiments of the method may be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

### LIST OF REFERENCE NUMERALS

10 Fluid system
20 Memory
30 Circle
31 Circle
32 Circle
33 Pressure value
34 Interpolating Curve
100 Pump
110 Fluid displacement mechanism
111 Inlet
112 Outlet
113 One-way valve
120 Pump drive
121 Motor
122 pump control circuit
130 Communications interface
200 Data processing unit
210 Processing unit
220 Memory
300 Data processing system
310 Processing unit
320 Memory
330 Interface
340 User-interface
400 Pressure sensor
500 Fluid dispensing point
600 Fluid conduit

1. A method for detecting leakage in a fluid system, comprising:
a) receiving a plurality of measured pressure values of a fluid pressure in the fluid system measured at different points in time;
b) computing, from the received pressure values, a first pressure gradient indicative of a gradient of the measured pressure values at a first point in time;
c) computing, from the received pressure values, a second pressure gradient indicative of a gradient of the measured pressure values at a second point in time, later than the first point in time, wherein the fluid pressure in the fluid system at the first point in time is higher than the fluid pressure in the fluid system at the second point in time;
d) comparing the magnitude of the second pressure gradient, which second pressure gradient is indicative of the gradient of the measured pressure values at the second point in time, with the magnitude of the first pressure gradient, which first pressure gradient is indicative of the gradient of the measured pressure values at the first point in time, and detecting presence of leakage responsive to the magnitude of the second pressure gradient being smaller than the magnitude of the first pressure gradient.

2. A method according to claim 1, wherein the fluid system comprises a pump configured to increase the fluid pressure in the fluid system, wherein the pump is controllable to selectively start and stop pump operation, and wherein the first point in time is selected as a point in time subsequent to a stop of the pump operation of the pump.

3. A method according to claim 2, wherein the second point in time is selected as a point in time prior to a start of pump operation of the pump and/or to a time of a detected increase in fluid pressure.

4. A method for detecting leakage in a fluid system, the fluid system comprising a pump configured to increase the fluid pressure in the fluid system, wherein the pump is controllable to selectively start and stop pump operation, wherein the method comprises:
a) receiving a plurality of measured pressure values of a fluid pressure in the fluid system measured at different points in time;
b) detecting a start time at which the pump starts a pump operation, and computing, from the received pressure values, a first pressure gradient indicative of a gradient of the measured pressure values at a first point in time prior to the detected start time;
c) detecting a stop time at which the pump stops a pump operation, the stop time being subsequent to the detected start time, and computing, from the received pressure values, a second pressure gradient indicative of a gradient of the measured pressure values at a second point in time subsequent to the detected stop time;
d) detecting presence of leakage from at least a comparison of the computed first and second pressure gradients with each other.

5. A method according to claim 1, further comprising:
monitoring the fluid pressure to detect at least one temporary pressure increase
selecting the first point in time as a time later than a detected end of one of the detected at least one temporary pressure increase, and
selecting the second point in time as a time prior to a detected onset of one of the at least one detected temporary pressure increase.

6. A method according to claim 1, further comprising:
e) computing a current leakage rate and/or a current leakage amount at least from one of the first and second pressure gradients.

7. A method according to claim 6, further comprising:
monitoring the fluid pressure during a time period between the first and second points in time,
responsive to detecting a temporary pressure increase during said time period between the first and second points in time, computing a modified current leakage rate and/or a modified current leakage amount to compensate for the detected temporary pressure increase.

8. A method according to claim 6, comprising issuing a notification to a user responsive to the current leakage rate and/or responsive to the current leakage amount.

9. A method according to claim 6, comprising:
repeating at least steps b) through e) in respect of respective first and second time intervals to compute respective current leakage rates and/or respective current leakage amounts associated with respective time intervals,
computing an aggregated leakage rate and/or an aggregated leakage amount from the respective current leakage rates and/or from the respective current leakage amounts.

10. A data processing system configured to perform the steps of the method defined in claim 1.

11. A pump for use in a fluid system, the pump comprising a processing unit (200) configured to control operation of the pump; wherein the processing unit is further configured to perform the steps of the method defined in claim 1.

12. A pump according to claim 11, further comprising a pressure sensor configured to measure pressure values, and wherein the processing unit is configured to receive the measured pressure values from the pump.

13. A pump according to claim 11, further comprising a non-return valve (113) at an inlet (111) of the pump.

14. A pump according to claim 11; comprising a communications interface for wired or wireless communication with a remote data processing system wherein the pump is configured to communicate measured pressure values and or computed leakage rates and/or amounts to the remote data processing system and/or wherein the pump is configured to receive configuration data from the remote data processing system.

15. A fluid system (10) comprising a pressure sensor (400) and a data processing system communicatively coupled to the pressure sensor; wherein the data processing system is configured to perform the steps of the method defined in claim 1.

16. A computer program comprising computer program code configured, when executed by a data processing system, to cause the data processing system to perform the steps of the method according to claim 1.
